(19) United States
(12) Patent Application Publication
(10) Pub. No.: US 2026/0246256 A1
(43) Pub. Date: Aug. 20, 2026

(54) SUPPLY SYSTEM FOR AN ELECTRICAL LINE, IN PARTICULAR FOR A CHARGING CABLE FOR AN ELECTRIC VEHICLE

(71) Applicant: IGUS GMBH, Koeln (DE)

(72) Inventors: Thilo-Alexander JAEKER, Sankt Augustin (DE); Christoph KOCH, Grafschaft (DE); Jörg OTTERSBACH, Bornheim (DE)

(21) Appl. No.: 18/859,685

(22) PCT Filed: Apr. 25, 2023
(86) PCT No.: PCT/EP2023/060858

§ 371 Date: Oct. 24, 2024

(30) Foreign Application Priority Data
Apr. 25, 2022 (DE) 10 2022 109 915.6
Feb. 1, 2023 (WO) PCT/EP2023/052489
Apr. 17, 2023 (DE) 20 2023 101 967.6

(51) Int. Cl. H02G 11/02; B60L 53/18

(52) U.S. Cl. CPC H02G 11/02; B60L 53/18

(57) ABSTRACT

A supply system for an electrical line, in particular for a cable for charging electric vehicles, comprising at least one cable store, wherein the cable store has a plurality of pulleys which are arranged in at least two pulley blocks in such a manner that a cable can be threaded into the pulley blocks in several windings, wherein a first pulley block and a second pulley block can be displaced relative to one another, at least one of the first and second pulley blocks is arranged on a linearly guided, displaceable pulley block carrier, and the first and the second pulley blocks can be moved on top of one another against a restoring force, wherein the supply system is in particular characterised in that the pulley block carrier is guided on and/or in at least one guide profile which is designed as a guide rail or forms at least one guide rail, the pulley block carrier is designed as a profile that is complementary to the guide profile, and the guide profile and the profile of the pulley block carrier engage in one another in a form-fitting manner such that an anti-tilt and anti-turn linear guiding of the pulley block carrier is effected in the direction of displacement.

### FIELD

The invention relates to a supply system with a return function or return device for a line, in particular electrical lines or cables, in particular for cables for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are adjustable or displaceable relative to each other, at least one of the first and second pulley blocks is arranged on a linearly guided, displaceable pulley block carrier, and the first and the second pulley block are movable towards each other against a restoring force.

### BACKGROUND

A supply system of the type described above is known for example from EP 3 271 983 B1. This published document describes an electrical connection system for charging a battery of a motor vehicle having a storage device for an electric cable comprising at least three pulleys, which are distributed in two rows, as well as a chain of spring elements, which are connected to the lower row and exert a holding force which increases with the length of the cable and a restoring force which decreases with the storage of the cable, wherein coil springs with different stiffnesses arranged in a row are provided as spring elements. This arrangement is to guarantee that an increasing holding force is generated as the cable is increasingly unwound and a decreasing restoring force is exerted as the cable is returned.

Further state of the art is known for example from JP 2014230298 A, which comprises a cable supply system with a cable store, in which pulleys are arranged in two pulley blocks, from which the cable can be unwound under tension, wherein both pulley blocks are resiliently mounted and in each case are displaceable against each other against the force of a tension spring. Another cable supply system is known from EP 2 813 455 A1, but this is primarily designed for network cables with a small cross section. It is intended to allow a simple installation or replacement of the cable but is not very suitable for cables for charging electric vehicles.

Finally, cable supply systems are known from the publications US 2017/203662 A1, EP 3 350 108 B1, DE 10 2019 104 131 A1, GB 2 574 735 A, US 2013/068870 A1, DE 10 2012 023 332 A1, EP 3 127 846 B1 and US 2016/089996.

The known supply systems are formed such that they are provided to the user completely ready for use with the corresponding cable. Any required replacement or a repair of the electrical lines or of the cable is not taken into account in the design of the known systems. Depending on the charging technology and provision of mains connections or mains connection points, it may be necessary to provide the supply system with electrical lines which are designed for different voltages and/or different currents. This requires that cables with different line cross sections be laid. In addition, depending on the installation location, there are different electrical safety requirements or different connectors must be provided. Therefore, it is in principle desirable that the user can easily lay electrical lines or cables themselves.

In addition, a compact and stable as well as in particular self-supporting installation of such a supply system is an important aspect, especially since the structural conditions do not always allow for a wall mounting, for example.

### SUMMARY

A first partial object of the present invention therefore relates to the provision of a supply system for electrical lines which is formed particularly simple and user-friendly with respect to maintenance and repair as well as with respect to being ready to use and in particular also with respect to installability.

In the case of the known supply systems, as well as in the case of the supply system according to the invention, while the cable is being unwound a particular restoring force is generated so that the cable can be retracted again automatically during stowing. It can happen that while it is being retracted into the cable store the free end of the cable is accelerated with decreasing length or over the duration of the winding-up process, with the result that a connector fastened to the end of the cable is stopped violently by the opening of a cable exit when the user lets go of the cable. In principle, in the case of such a simple configuration of the supply system it would be necessary for the user to hold on to the cable during the winding-up process while exerting tension, in order to be able to carry out a winding-up process that is as gentle as possible for the cable. In the course of operating the supply system with average attentiveness by the user, it is to be assumed that the user will not pay attention, during every operation, to holding on to the cable over the entire winding-up process.

In principle, it would therefore be desirable to provide a supply system of the type mentioned at the beginning with increased operating safety and with increased ease of use for the user.

The invention is therefore based on the further partial object of providing a supply system which guarantees a safe, convenient and user-friendly process for winding the cable up.

Further advantageous embodiment examples of the invention are in each case covered by the dependent claims, which can in principle also be combined with each other for all aspects of the invention and are also to be understood as disclosed within the framework of the invention in combination.

### FIRST ASPECT (Mounting on One Side)

A first aspect of the invention relates to a supply system with a retracting function or retracting device for lines, in particular for cables for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are movable or displaceable relative to each other, at least one of the first and second pulley blocks is arranged on a linearly guided, displaceable pulley block carrier, and the first and the second pulley block are movable towards each other against a restoring force, wherein the supply system according to the first aspect of the invention is characterized among other things in that the pulley block carrier is guided on and/or in at least one guide profile which is formed as a guide rail, in that the pulley block carrier is formed as a profile that is complementary to and/or compatible with the guide profile and in that the guide profile and the profile of the pulley block carrier engage in each other in a positive-locking manner such that an anti-tilt and anti-twist linear guidance of the pulley block carrier is brought about in the displacement direction.

Within the meaning of the invention, “in a positive-locking manner” means that at least one degree of freedom is limited transverse to the displacement direction of a pulley block by virtue of the cooperation of the profiles.

In the case of a mounting of the pulley blocks on one side, a compact and stable as well as in particular self-supporting installation of the supply system can in particular be brought about thereby, wherein the profile of the guide rail guarantees that corresponding moments and forces can be safely absorbed.

The pulley block carrier is preferably guided in at least one guide profile which is arranged preferably centrally and furthermore preferably vertically in the installed position and which is formed as a guide rail or forms at least one guide rail. This embodiment of the supply system according to the invention has the advantage that a housing is not necessary for the functionality and in particular as a supporting design element of the supply system.

The guide rail can be provided with at least one foot, with the result that the supply system can be installed freestanding. Alternatively, a wall mounting is of course also provided within the framework of the invention. Ideally, the supply system according to the invention is formed such that the user has the choice between a freestanding installation and a wall mounting.

Finally, the guide rail can furthermore additionally be arranged inside a housing, wherein in this case the housing is not necessary for the functionality of the supply system but only provides a protective function and possibly an anti-theft protection.

The guide rail can for example be formed as a C profile or a U profile. Alternatively, the guide rail can comprise one or more guide bars formed T-shaped or I-shaped, around which a contour of the pulley block carrier formed compatible or complementary can grip, preferably in a positive-locking manner.

The guide profile is preferably formed as a central guide column which can be installed in a self-supporting manner.

By “in a self-supporting manner” is meant, generally and within the meaning of the invention, the implementation of a central design element when the latter does not need further external load-bearing elements in order to fulfil its function.

The guide profile can be designed or formed as a supporting component part, in particular for both pulley block carriers, the cable laid thereon as well as the retracting mechanism, and optionally also for any further components.

The first pulley block is preferably arranged fixed in position. In such a case it is advantageous if the second pulley block is displaceable with respect to the first pulley block on the pulley block carrier, e.g. is mounted relatively movable. The pulley block carrier can for example be formed as a carriage guided by means of rollers or sliding bearings. It is sufficient in principle if only the second pulley block is relatively movable, which simplifies the design.

The housing can accommodate electrotechnical devices and/or component parts for charging electric vehicles and, for this, can have, for example, a separate and/or sealed accommodating area or a separate and/or sealed compartment, preferably with a suitable IP class.

In a preferred embodiment of the invention, it is provided that the pulley blocks and/or the pulley block carriers are mounted or attached or are supported on one side and cantilevered.

The fact that the pulley block carriers are mounted on one side and cantilevered is especially advantageous in particular because the pulley blocks are thus accessible on one side in such a way that a cable can be laid from one side without having to be threaded through awkwardly, as would otherwise be the case in closed pulley blocks. Owing to this design, the first pulley block can for example be fastened to a wall on one side, whereas the second pulley block can be mounted on an axle fastened on one side and cantilevered on a pulley block carrier preferably formed as a carriage. In this way, it is possible both to lay the cable on one side and to replace or lay individual pulley wheels or pulleys. The pulleys or the pulley wheels can likewise be ball bearing mounted or sliding bearing mounted, wherein polymer bearings can also be provided for this purpose.

In the present case “mounted cantilevered” means mounted or held in particular only on one side with an unsupported opposite region, for instance in the sense of a cantilever arm or cantilever beam. As a result of this, the pulley blocks are easily accessible from the free side since no fastening or the like needs to be released here.

By the term “to thread into” or “to reeve”, or “can be reeved”, is meant, in relation to the pulley blocks, an arrangement in which the cable is laid or inserted, or can be laid or inserted, on or in the pulley blocks in multiple windings, similarly to a block and tackle, or just tackle.

In a variant, the pulley block carrier can have a C-or U-shaped cross-sectional profile, which is open in the direction of the extent of an axle, with the result that the pulley block or the pulley wheels are easily accessible from one side in any case. The pulley block carrier can be formed as a plastic profile which has two face sides, each forming a lateral side piece of the pulley block carrier, on which guide rollers can be arranged, for example.

The pulley block carrier is preferably formed as a carriage which is supported on guide bars or profiled belts of the guide profile via guide rollers and/or via sliding guides.

The axles can each accommodate a plurality of individual pulleys mounted rotatable independently of each other, which can, for example, consist of identically formed pulley wheels, which are each formed as injection-molded plastic parts.

It is particularly expedient and advantageous if the housing has housing parts which can be removed by a user and which are formed such that the user can lay the connected charging cable with a connected charging plug on the pulleys when the housing is open. This guarantees that the supply system according to the invention can for example be retrofitted in domestic installations without the user needing to interfere with live parts of the charging station.

The housing can have at least one cable entry and at least one cable exit, which are formed such that the user can lay a cable, connected at least at one end and provided with a charging plug, on the pulleys without removing the charging plug or plugs from the cable.

In this connection it is advantageous and expedient if the housing can be opened by the user with simple handles. In the case of such a configuration of the housing, it makes sense for the cable to have an anti-theft protection and/or a protection against being pulled out.

The second pulley block is preferably fastened to the pulley block carrier on one side and cantilevered, wherein at least one pulley block preferably has in each case multiple pulleys arranged distributed in an arc shape over a circular arc around a deflection axis and at least one of the first and second pulley blocks is arranged and held on the displaceable pulley block carrier. In particular when the pulley blocks are each arranged on a partial circular arc which extends in each case over an angular range of not much more than 180 degrees, this has the advantage that a greater displacement distance can be achieved for the pulley block carrier.

In a particularly preferred variant of the supply system according to the invention it can be provided that the guide profile has at least one hole pattern and/or tooth pattern continuing at least in the displacement direction of the pulley block carrier as part of a return stop acting against the restoring force. In this way, a return stop for the cable is realized, which can absorb relatively large forces.

The return stop is preferably formed as a retaining pawl which also guarantees, for example, that the cable is pulled out and fixed or locked in a plurality of discrete positions with the smallest possible amount of effort.

In an advantageous embodiment, the return stop is formed such that, in the displacement direction of the pulley block carrier, it comprises a plurality of discrete locking positions and a plurality of discrete release positions provided between the locking positions for at least one pawl, which can be deflected against a spring force, and which is preferably mounted deflectable against a spring force on the pulley block carrier. Within the meaning of the invention, discrete means a finite countable quantity of positions.

This embodiment has the advantage in particular that the user can actuate or choose a release position or a locking position for the cable return in a targeted manner by applying more or less tension to the cable.

For this, the guide profile can comprise at least one hole pattern extending in the displacement direction of the pulley block carrier, wherein the hole pattern comprises a plurality of first smaller holes which each form a locking position for a pawl engaging in them and wherein the hole pattern comprises a plurality of second larger holes which each form a release position for a pawl dipping into them.

The return stop can for example comprise at least one pawl, which has at least one locking tooth and at least one sliding tooth, wherein the locking tooth is formed to engage with the hole pattern and the sliding tooth is arranged offset parallel to a pivot axis of the pawl and formed as a pivot limit stop for the pawl. The pawl can be formed with the sliding tooth as a plastic component part which is formed in one part or in one piece, for example of a filled and/or fiber-reinforced thermoplastic. The teeth of the pawl are preferably arranged parallel to each other in relation to a pivot axis and offset with respect to each other in relation to a circumferential direction.

The size of the larger holes is expediently dimensioned such that they have a width transverse to the displacement direction of the pulley block carrier which enables a returning movement of the pawl into a neutral position in which both a returning movement and a pulling-out movement of the cable is possible. The holes can for example be formed as rectangular openings or recesses in the guide profile.

The pawl is preferably held spring-loaded in the neutral position. In the case of a displacement such that the pawl comes out of engagement with the larger holes of the hole pattern, the sliding tooth rests against a surface of the guide profile and thus expediently limits the pivoting movement of the pawl.

The neutral position of the pawl corresponds to a release position, in which the pawl is freely deflectable in any pivoting direction, depending on the direction in which the pulley block carrier is displaced.

### SECOND ASPECT (Return Stop)

A second aspect of the invention, for which protection is claimed independently, relates to a supply system with a particularly advantageous return stop for the cable. This aspect is subordinate to the superordinate problem or the task of guaranteeing a compact and stable as well as in particular self-supporting installation of a supply system.

According to the second aspect, a supply system for an electrical line, in particular for a cable for charging electric vehicles, is provided, wherein the supply system comprises at least one cable store, wherein the cable store comprises a plurality of pulleys, which are arranged in at least two pulley blocks such that a cable can be reeved into the pulley blocks in multiple windings, wherein a first pulley block and a second pulley block are displaceable relative to each other, at least one of the first and second pulley blocks is arranged on a linearly guided, displaceable pulley block carrier, and the first and the second pulley block are movable towards each other against a restoring force, wherein the supply system is characterized in particular in that the pulley block carrier is guided on and/or in at least one guide profile which is formed as a guide rail and in that at least one return stop acting against the restoring force, which acts between the at least one guide profile and the pulley block carrier and which is preferably formed as a retaining pawl, is provided for at least one pulley block carrier.

In particular due to the fact that the return stop acts directly between the pulley block carrier and the guide profile, a compact, space-saving return stop is realized, which can absorb large forces and moments.

The return stop can be formed corresponding to the return stop which was described above in connection with the first aspect of the invention. To this extent the features of both aspects of the invention can be interchanged and combined. With respect to their advantages, reference is also made to the above statements.

In a particularly advantageous variant of the invention, it is provided that, in the displacement direction of the pulley block carrier, the return stop comprises a plurality of discrete locking positions and a plurality of discrete release positions provided between the locking positions for at least one pawl, which is preferably mounted deflectable against a spring force on the pulley block carrier.

The guide profile can have at least one hole pattern and/or tooth pattern continuing in the displacement direction of the pulley block carrier as part of the return stop. The guide profile preferably has at least one hole pattern extending in the displacement direction of the pulley block carrier, wherein the hole pattern comprises a plurality of first smaller holes which each form a locking position for a pawl engaging in them and wherein the hole pattern comprises a plurality of second larger holes which each form a release position for a pawl dipping into them.

In an expedient variant of the invention it is provided that the guide profile, which is formed for example as a U profile or C profile, has at least two preferably parallel hole pattern lines, which each extend in the longitudinal direction of the guide profile and which each form a plurality of locking positions and release positions defined by the size of the holes, wherein in each case one release position is preferably provided between a multiplicity of locking positions or possible locking engagements for a pawl. Depending on the hole pattern line, an associated pawl is provided at the corresponding point of the pulley block carrier.

According to the invention it can be provided that the return stop comprises at least one pawl, preferably at least two pawls, which have at least one locking tooth and at least one sliding tooth, wherein the locking tooth is formed to engage with the hole pattern and the sliding tooth is arranged offset parallel to a pivot axis of the pawl and formed as a pivot limit stop for the pawl. The at least one pawl is preferably resiliently held in a neutral position or pretensioned in a neutral position.

The preferred features of the first and second aspect can advantageously be combined with each other and can be viewed as significant to the invention for each of the aspects.

### GENERAL

The supply system has, as a function, the automatic returning or retracting of the guided line and in this respect can also be called a return system. It preferably provides a length of cable that can be pulled out of at least 2 meters, but preferably at least 3 meters.

In principle, the supply system is claimed without a cable but can particularly advantageously be used in combination with a cable, in particular a cable for charging electric vehicles. As cables for charging electric vehicles, e.g. with a purely electric drive (battery electric vehicles) or with a partially electric drive (plug-in hybrid vehicles), cables suitable for this according to the usual standard come into consideration in particular. These cables are, e.g. in Europe, often designed with a connector according to the standard IEC 62196 or as a so-called Type 2 connector or e.g. as a so-called Combo 2 connector or coupling for direct current charging with up to 240 kW at 200-600 V direct voltage and up to 400 A direct current. In addition, there are further standards for plug connectors and charging cables. The charging cable is designed for a correspondingly typical load, in any case of at least 10 kW, and preferably has a corresponding charging plug for an electric vehicle, in particular a charging plug according to the standard IEC 62196-1 (2016) or standard IEC 62196-2 (2016) (e.g. Type 1/Type 2/Type 3), at the end which can be pulled out.

Since the charging cable has to carry a high electrical power typically of at least 11 kW, usually at least 22 kW, corresponding core cross sections (e.g. typically 5 G 6 mm 2), core insulation as well as a sheath with the necessary mechanical protection are required. This makes such a charging cable, with a typical total cable cross section ≥15 mm, correspondingly heavy and stiff, with the result that it requires effort to wind up by hand. Here, the invention in all its aspects, in particular for or with charging cables of this type, makes the handling much easier for the user and also simplifies and reduces the cost of producing a charging column or charging station.

### BRIEF DESCRIPTION OF THE DRAWINGS

The invention is explained below with reference to and on the basis of an embodiment example represented in the accompanying drawings, which embodies one of several possible specific variants of the invention. There are shown in:

FIG. 1a is a perspective view of the supply system according to the invention;

FIG. 1b is a front view of the supply system according to Figure la;

FIG. 1c is a view of the representation according to FIG. 1b rotated 90°;

FIG. 2 is a representation from the front of the supply system without the pulley blocks with the laid cables;

FIGS. 3a-3d are various representations of a pulley block according to the invention;

FIG. 4a is a front view of the supply system according to the invention, in which the position of the pulley blocks corresponds to the cable being almost completely pulled out from the supply device;

FIG. 4b is a sectional view along the lines A-A in FIG. 4a, in which the return stop of the supply system is located in a blocked position preventing the return of the cable;

FIGS. 4c-4d are views which correspond to those of FIGS. 4a and 4b, wherein the return stop according to detail D in FIG. 4d is located in a neutral position;

FIGS. 4e-4f are views corresponding to FIGS. 4a and 4b, wherein the return stop according to detail F in FIG. 4f is located in a position in which a return of the cable is permitted; FIG. 5 a is an enlarged view of detail B in FIG. 4 b;

FIG. 5 b is an enlarged view of detail D in FIG. 4 d;

FIG. 5 c is an enlarged view of detail F in FIG. 4 f;

FIGS. 6a-6d are various views of a pawl;

FIG. 7 is a front view of a further embodiment example of the supply system according to the invention;

FIG. 8 is a perspective view of the supply system according to FIG. 7;

FIG. 9 is a perspective back view of the supply system according to FIG. 7;

FIG. 10A is a cross section through the supply system according to the embodiment example from FIG. 7; and

FIG. 10B is a perspective view of the pulley block carrier from FIG. 10A.

### DETAILED DESCRIPTION

The supply system 1 according to the invention comprises a cable store for a cable 3 as charging cable for an electric vehicle. The cable store of the supply system 1 comprises a first, upper pulley block 109 arranged fixed in position and a second lower pulley block 110 displaceable relative thereto, over or on which the cable 3 can be reeved in multiple windings or laid. The first, upper pulley block 109 is screwed fixed in position to a central support and guide profile 134. The second pulley block 110 is mounted vertically slidable relative to the first pulley block 109. The second pulley block 110 is arranged vertically mobile or adjustable on or in the guide profile 134 by means of a pulley block carrier 113 formed as a carriage.

The cable 3 is laid on the pulley blocks 109,110 with a plurality of windings and in each case deflected around an imaginary axis, which extends transverse to the displacement direction of the second or lower pulley block 110. The cable comprises a free end 17 to which a charging plug, not represented, can be connected as well as a connection end 8 which is fixed in a clamping block 9 and guided by the latter to a voltage source.

The clamping block 9 and an exit guide 10 with a small roller arrangement 16 are arranged on a holding arm 11, which is in turn fastened to the guide profile 134. The clamping block 9 comprises two plastic common parts, which form a lead-through the diameter of which is smaller than the cable diameter, with the result that the cable 3 can be clamped in this lead-through gently. The small roller arrangement 16 comprises three rotatably mounted small rollers 37 arranged in a U shape.

The pulley blocks 109,110 in each case comprise multiple pulleys 140 arranged distributed in an arc shape over a circular arc around an imaginary deflection axis, wherein in each case pulley groups with multiple pulleys 140, here four pulleys, are arranged distributed in an arc shape over a circular arc. The second pulley block 110 including all of its pulleys 140 arranged distributed over a circular arc is arranged on the linearly guided, displaceable pulley block carrier 113 and adjustable therewith.

Each of the two pulley blocks 109,110 comprises pulley groups or pulleys 140 which are arranged distributed over a circular arc the arc measure of which is slightly smaller than 180°. Arranged in each of the two pulley blocks 109,110 are at least four, here five, pulley groups distributed at an identical angular dimension around an imaginary deflection axis, which is perpendicular to a guide plane which defines the guide profile 134 for the pulley block carrier 113.

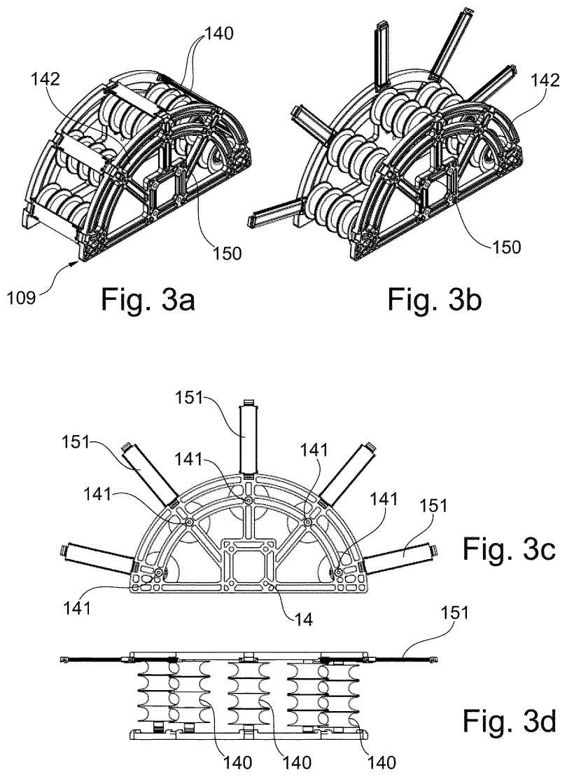

As can be seen in particular from FIGS. 3a to 3d, each of the two substantially structurally identically designed pulley blocks 109,110 comprises a semicircular frame 142 with pulley axles 141 uniformly distributed over the circular arc portion. Each pulley axle 141 bears in each case four pulleys 140 arranged coaxial to each other.

All pulleys 140 are preferably formed as cable-protecting plastic pulleys with an approximately semicircular cross-sectional profile for holding and guiding the cable 3. The pulley axles 141 of the pulley group are each held on and fastened to two axially opposite, structurally identical carrier elements 150, which define the circular arc for the pulley axles 141, in a framework construction or in a skeleton construction.

As can be seen in particular from FIG. 3d, pulleys 140 arranged one after the other in the arc direction are mounted axially offset with respect to each other on the pulley axles 141, with the result that an offset of the cable 3 during the transition from one pulley block 109,110 to the next pulley block 109,110 is minimized. Each pulley block is positioned offset by a few millimeters with respect to the subsequent pulley block, with the result that the cable needs to overcome no or only a very small offset at the transition from one pulley block 109,110 to the other.

Each frame 142 is formed such that it forms a pulley cage or pulley block for securely holding the individual windings of the cable 3 on the pulleys 140. Each pulley block 109,110 comprises, radially outwardly offset with respect to the pulley axles 141, securing bars 151 which are arranged at a regular angular spacing from each other and are fastened to one of the two carrier elements 150 so as to be able to fold out or swivel out.

FIG. 3a shows the securing bars 151 in the closed and swiveled-in state. FIG. 3b shows the securing bars in the open and folded-out state.

The pulley blocks 109,110 form a block and tackle with the cable 3 laid and reeved, in multiple windings, on them, wherein a pull on the free end 17 of the cable (for reasons of simplification a connector is not represented) pulls the cable 3 out in such a way that the pulley block carrier 113 is lifted towards the first pulley block 109, wherein the cable portions located between the pulley blocks 109,110 shorten and the pulled-out length of the cable 3 increases. The distance by which the cable 3 can be pulled out is naturally a multiple of the spacing of the pulley blocks 109,110 from each other, wherein the force to be applied in the process is a fraction of the force which acts on each individual portion of the cable 3.

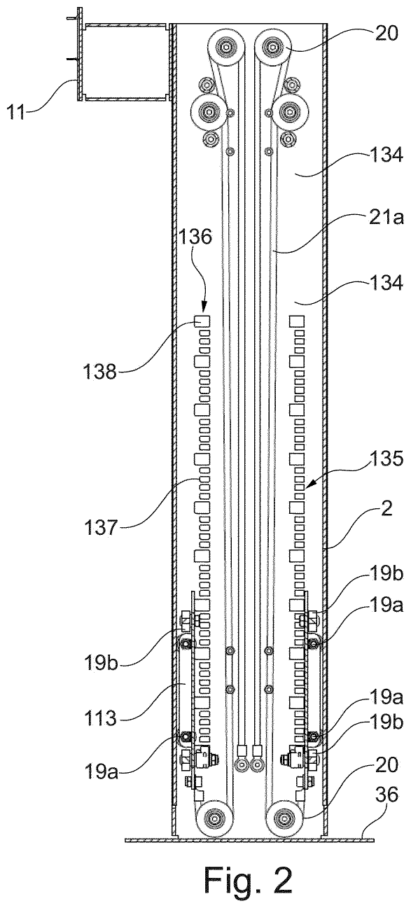

As can be seen in particular from the longitudinal section through the supply system 1 represented in FIG. 2, the pulley block carrier 113 is formed as a holding plate with a U-shaped profile in cross section, to the side pieces 18 of which guide rollers 19a, 19b, which are supported within the guide profile 134 between guide bars 2 and the back wall of the guide profile 134, are fastened. The guide profile 134 is formed as a C-shaped profile in cross section, the profile side pieces 12 of which overlap the pulley block carrier 113.

In the example represented in FIG. 2, in each case two groups with four guide rollers 19a, 19b are provided, which are supported in two perpendicular directions against tilting on the inside of the guide profile 134. The guide rollers 19a are supported against tilting about the imaginary deflection axis of the pulley block 110, and the guide rollers 19b are supported against tilting about a horizontal axis perpendicular to the imaginary deflection axis. Instead of a guidance with rollers which engage on the inside of the guide profile 134, a reverse arrangement is also possible, with a guidance on the outside of a corresponding profile. However, the guidance on the inside provides better protection of the guidance.

The pulley block carrier 113 and the guide profile 134 engage in each other in a positive-locking manner in such a way that a rotational and tilting movement about an axis perpendicular to the displacement direction of the pulley block carrier 113 is prevented. The cross-sectional profiles of the guide profile 134 on the one hand and of the pulley block carrier 113 on the other hand are each designed as U profiles, but they could also be formed as C profiles engaging in each other. Moreover, instead of a roller guide a sliding guide can also be provided between the profiles.

The pulley block carrier 113 is displaceable against the spring force of two expander cords 21a towards the upper first pulley block 109 that is fixed in position. The expander cords 21a are fastened to the back of the pulley block carrier 113 on the one hand and to the guide profile 134 on the other hand. Two deflection rollers 20 for the expander cords 21a are arranged in each case at the upper and at the lower end of the guide profile 34. The expander cords 21a each act as spring elements which generate a restoring force for the pulley block carrier 113. These are guided in each case at the top and bottom over the deflection rollers 20 in multiple parallel portions.

The pulley block carrier 113 is displaced towards the first, upper pulley block 109 against the spring force of the expander cords 21a, which generate a restoring force that increases in proportion to the pulled-out length of the cable 3.

Alternatively, the restoring force for the pulley block carrier 113 can be generated via other spring elements, for example via gas springs, coil springs or the like.

The guide profile 134 can be formed as a central guide column which comprises, for example, a footplate 36 for the freestanding installation on level ground. Alternatively, the guide profile 134 can be formed with corresponding fastening means (not shown) for wall mounting.

In principle, the supply system 1 can comprise a housing, not represented, which does not undertake a supporting function, however, but rather serves only to clad the supply system 1.

The supply system 1 according to the invention furthermore comprises a return stop, which acts between the pulley block carrier 113 and the guide profile 134 and with which the displaceable lower, second pulley block 110 can be blocked in a plurality of discrete, i.e. countable, positions. This blocking or locking can be overridden by a user by pulling on the cable and displacing the lower second pulley block 110 in specific predefined positions of the pulley block carrier 113.

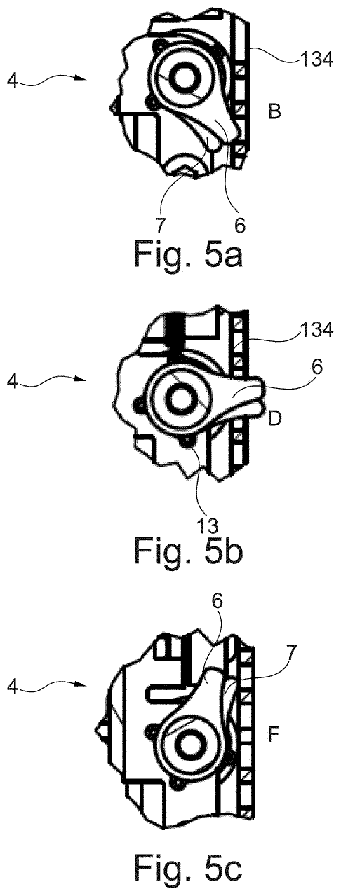

The return stop is explained below with reference to FIGS. 5a to 5c.

The pulley block carrier 113 comprises two pivotably mounted pawls 4, which are forced or loaded into a release position represented in FIG. 5b by means of a spring. One of the pawls 4 is represented in various views 6a to 6d.

The pawls 4 pivotably articulated to the pulley block carrier 113 in each case cooperate with a hole pattern 135 of the guide profile 134. The hole pattern 135 comprises two hole pattern lines 136 running parallel at a spacing from each other, which extend in the longitudinal direction of the guide profile 134 and comprise a plurality of rectangular smaller holes 137 as well as a plurality of rectangular larger holes 138. In the embodiment example described, in each case four smaller holes 137 arranged immediately one after the other are provided between two larger holes 138 in each hole pattern line 136. The smaller holes 137 each define locking positions for the pulley block carrier 113, whereas the larger holes 138 each form release positions for the pawls 4 in which the pulley block carrier 113 is freely displaceable vertically in either direction.

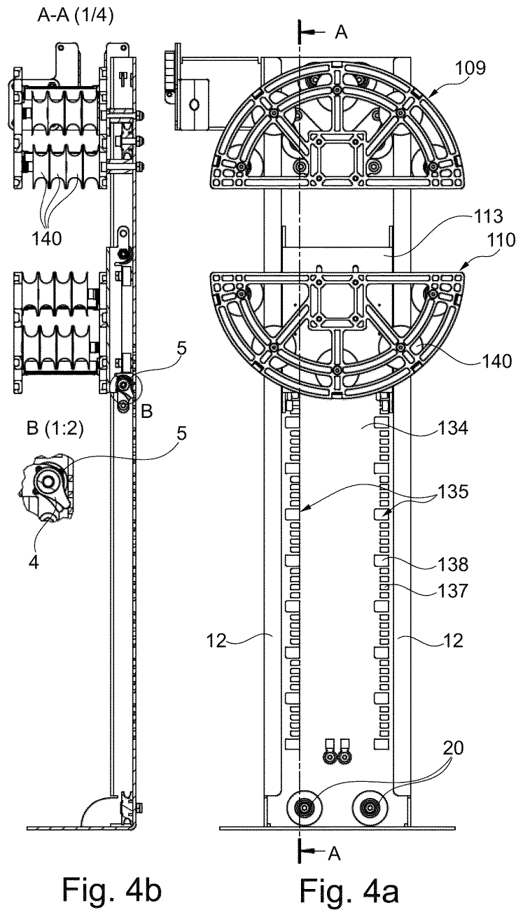

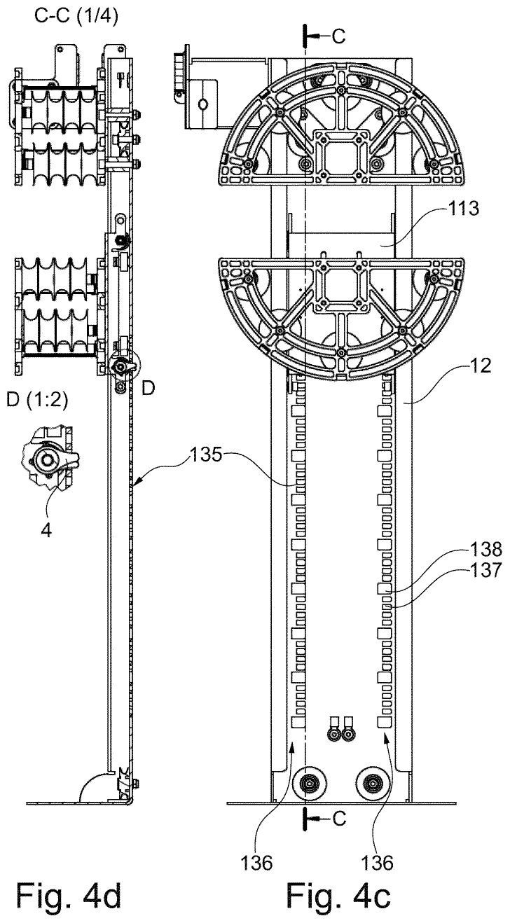

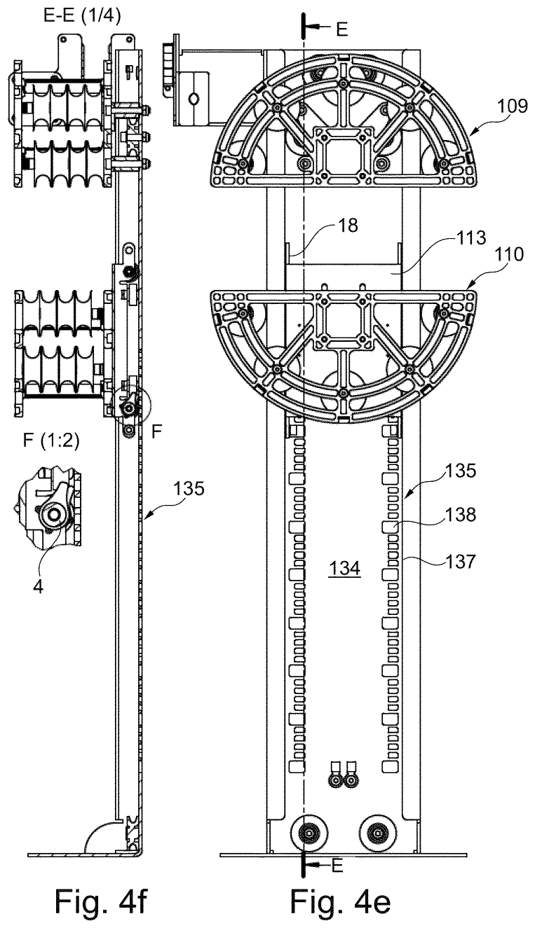

Views B, D and F in FIGS. 5a to 5c in each case show the cooperation of the pawls 4 with the hole pattern 135. Details B, D and F are shown in FIGS. 4b, 4d and 4f in each case in connection with a position of the second, lower pulley block 110 or of the pulley block carrier 113.

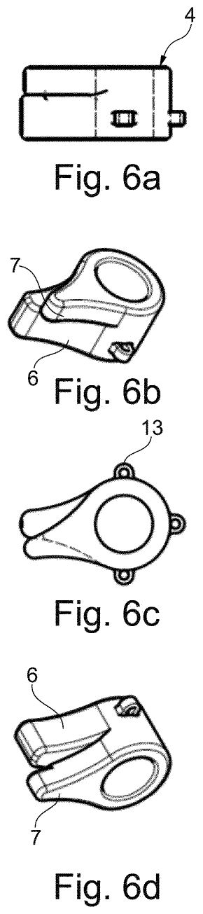

FIGS. 6a to 6d in particular also show the formation of the pawls 4. Each of the pawls 4 comprises a locking tooth 6 and a sliding tooth 7, which are arranged parallel to each other in the direction of a pivot axis of the pawls 4 and offset with respect to each other in the circumferential direction. The sliding tooth 7 is slightly narrower in the direction of the pivot axis than the locking tooth 6, which is dimensioned thicker due to the weight force of the lower pulley block 110 to be absorbed by it. The locking tooth 6 cooperates with the smaller holes 137 of the hole pattern 136, whereas the sliding tooth 7 rests on the surface of the guide profile 134 not penetrated by holes 137,138 both in a locking position and in a release position and acts as a pivot limit stop for the pawl 4. On its outer circumference 3, each pawl 4 comprises eyelets 13, which are arranged with equal spacing from each other and which serve to fasten the springs 5.

The larger holes 138 are wider than the smaller holes 137, i.e. they have a greater extent in a direction transverse to the displacement direction of the pulley block carrier 113 than the smaller holes 137. The width of the larger holes 138 is slightly larger than the entire width of the pawl 4, with the result that the pawls 4 can dip into the larger holes 138 completely in the release position or neutral position.

The release position of the pawl 4 is represented in FIG. 5b (detail D). The springs 5, which can be formed, for example, as coil springs, engaging on the pawls 4 hold the pawls 4 in the release position shown in FIG. 5b, i.e. in the 3 o'clock position viewed from the side. A pivoting of the pawls 4 clockwise and anticlockwise (based on the side view in FIG. 5) brings about a deflection of the pawl 4 against the restoring force of the spring 5. Starting from the release position shown in FIG. 5, in which the pawl 4 in question dips into the larger hole 138 completely, the pulley block carrier 113 with the lower pulley block 110 can be displaced both upwards towards the upper pulley block 109 and downwards away from the upper pulley block 109. If the pulley block carrier 113 of the lower pulley block 110 is displaced upwards by pulling on the cable 3, the pawl 4 is deflected anticlockwise into a position such as is represented in FIG. 5a (detail B). The locking tooth 6 and the smaller sliding tooth 7 come out of engagement with the large hole 138 and, in the case of an upwards movement of the pulley block carrier 113, the pawl 4 slides over the hole pattern 136, wherein the sliding tooth 7 rests on the unperforated surface of the guide profile 134 and acts as a pivot limit stop for the pawl 4.

If the pulley block carrier 113 with the lower pulley block 110 moves in the opposite direction, thus away from the upper pulley block 109, the locking tooth 6 engages in the smaller holes 137 such that a downwards movement of the pulley block carrier is blocked.

Starting from the release position or neutral position of the pawl 4 shown in FIG. 5b (detail D), a relief of the strain on the cable 3 brings about a deflection of the pawl 4 anticlockwise, wherein it is brought out of engagement with the larger hole 138. This pivoting movement also takes place against the spring force of the spring 5. The pulley block carrier 113 with the lower pulley block 110 can in this case be moved into the lower position shown in Figure la, wherein the sliding tooth 7 rests on the unperforated smooth surface of the guide profile 134 and keeps the locking tooth 6 out of engagement with the hole pattern 136.

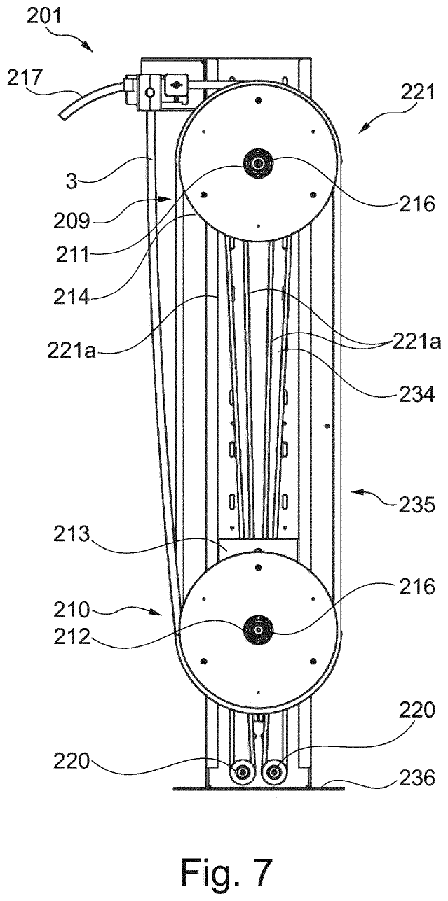

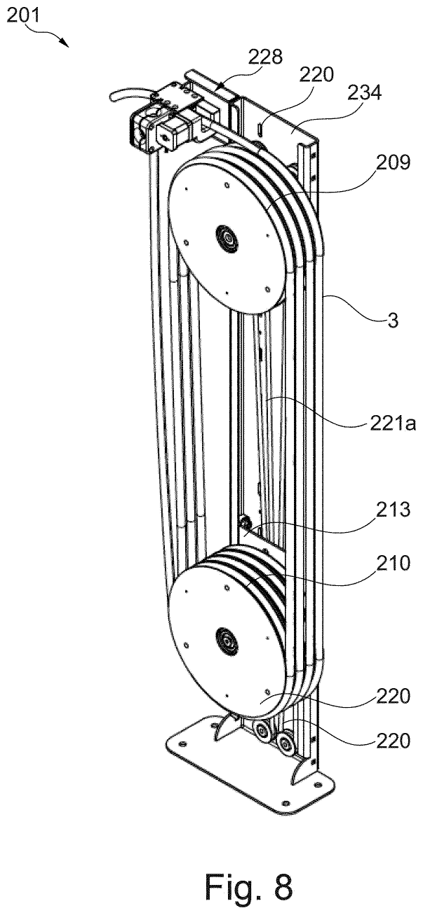

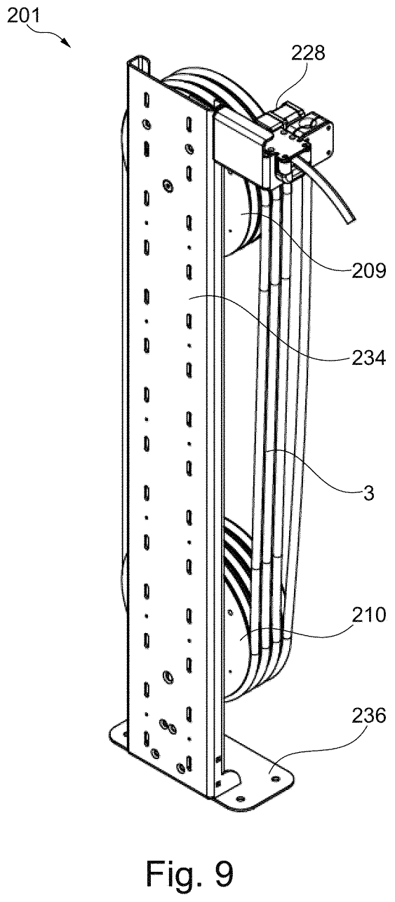

Reference is now made to FIGS. 7 to 10A-10B, which show a second embodiment example according to the invention. An important difference is the simpler construction of the pulley blocks, but they require more installation height in comparison with the first example.

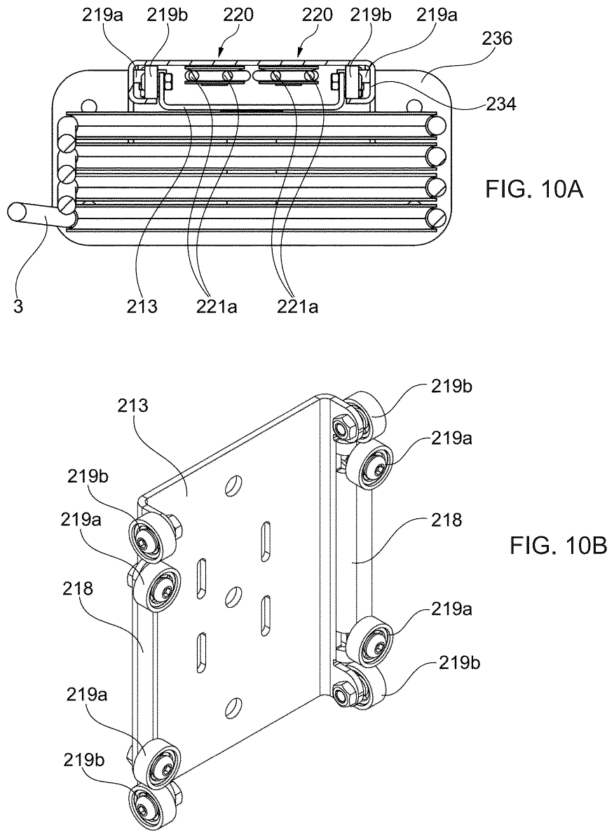

The supply system 201 comprises a cable store for a cable 3 as charging cable for an electric vehicle. The cable store of the supply system 201 comprises a first, upper pulley block 209 arranged fixed in position and a second, lower pulley block 210 displaceable relative thereto. The first pulley block 209 is mounted on a first axle 211, which is fastened cantilevered to a guide profile 234 of a frame 235, whereas the second pulley block 210 is mounted on a second axle 212, which is fastened cantilevered on a pulley block carrier 213, which is displaceable guided on the guide profile 234. As can be seen from FIGS. 10A-10B, the guide profile 234 is formed as a profile rail which is formed with a C-shaped cross section, and which is supported against and fastened to the ground by means of a footplate 236. The pulley block carrier 213 to which the displaceable pulley block 210 is fastened is arranged slidingly displaceable within the guide profile 234, with the result that the pulley blocks 209, 210 are movable towards each other and away from each other.

The pulley blocks 209, 210 each comprise four pulleys 214 mounted individually rotatable independently of each other, which in turn are made up of individual pulley wheels. The pulleys 214 are mounted in each case on ball bearings 216, which are seated on the axles 211,212.

The pulley blocks 209, 210 form a block and tackle with the cable 3 laid and reeved, in multiple windings, on them, wherein a pull on the free end 217 of the cable 3 (for reasons of simplification a connector is not represented) pulls the cable 3 out in such a way that the pulley block carrier 213 is lifted towards the first pulley block 209, wherein the cable portions located between the pulley blocks 209,210 shorten and the pulled-out length of the cable 3 increases. The distance by which the cable 3 can be pulled out is naturally a multiple of the spacing of the pulley blocks 209,210 from each other, wherein the force to be applied in the process is a fraction of the force which acts on each individual portion of the cable 3.

The pulley block carrier 213 is formed as a holding plate with a U-shaped profile in cross section, to the side pieces 218 of which guide rollers 219a, 219b, which are guided within the guide profile 234 between guide bars and the back wall of the guide profile 234, are fastened. In the example according to FIGS. 7-10, as FIG. 10b shows, in each case two groups with four guide rollers 219a, 219b are provided, which are supported in two perpendicular directions against tilting on the inside of the guide profile 234. The guide rollers 219a support against tilting about the axis of rotation of the pulley block 210, and the guide rollers 219b support against tilting about a horizontal axis perpendicular to the axis of rotation. Instead of a guidance with rollers which engage on the inside of the guide profile 234, a reverse arrangement is also possible, with a guidance on the outside of a corresponding profile. However, the guidance on the inside provides better protection of the guidance.

The pulley block carrier 213 is displaceable against the spring force of two expander cords 221a towards the upper first pulley block 209 that is fixed in position. The expander cords 221a are fastened to the back of the pulley block carrier 213 on the one hand and to the guide profile 234 on the other hand. Two deflection rollers 220 for the expander cords 221a are arranged in each case at the upper and at the lower end of the guide profile 234. The expander cords 221a, as spring elements which generate a restoring force for the pulley block carrier 213, are guided in each case at the top and bottom over the deflection rollers in multiple parallel portions.

The pulley block carrier 213 is displaced towards the first, upper pulley block 209 against the spring force of the expander cords 221a, which generate a restoring force that increases in proportion to the pulled-out length of the cable. Due to the fact that in each case an expander cord 221a is guided over an upper and a lower deflection roller 220, it is possible to provide relatively long spring elements with a relatively small spring constant in a space-saving manner. The spring characteristic resulting from this is relatively flat and gives the user the feeling that they can pull the cable 3 out of the cable store with almost constant force.

Owing to the guide profile 134 or 234, a housing, not shown, of any desired construction, which is preferably made up of multiple housing parts, can be used with the supply system proposed here. Of course, the invention is to be understood such that the type of cable 3 for the supply system is not important. Other constructions with a guide profile and pulley block carrier, which are complementary to each other, also lie within the framework of the invention.

### List of Reference Numbers

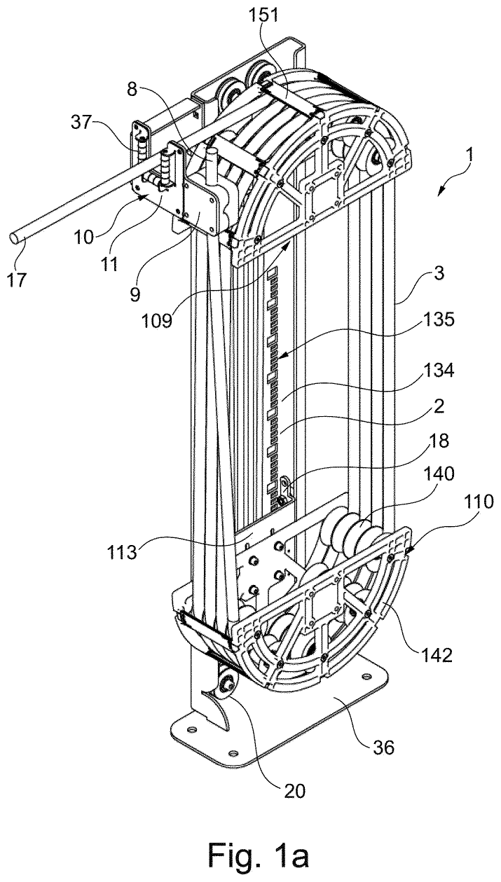

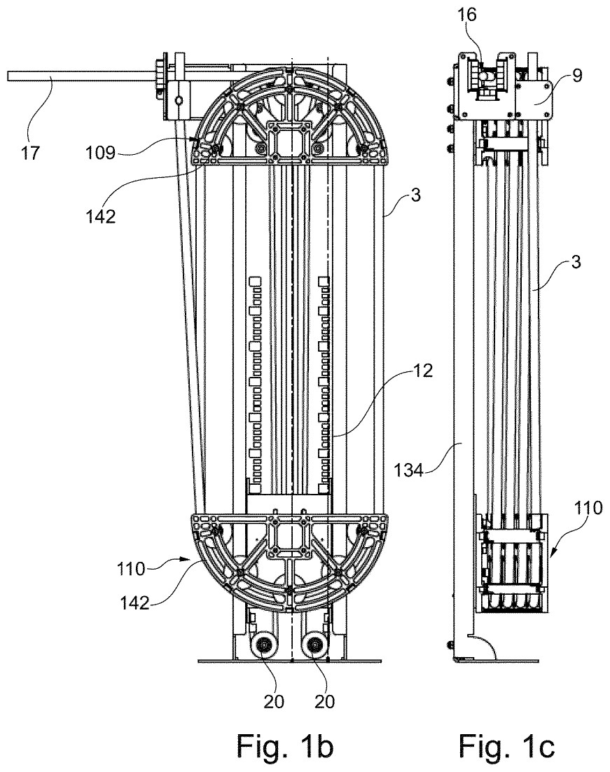

### FIGS. 1-6

1 supply system
2 guide bars
3 cable
4 pawls
5 springs
6 locking tooth
7 sliding tooth
8 connection end
9 clamping block
10 exit guide
11 holding arm
12 profile side piece
13 eyelets
16 small roller arrangement
17 free end of the cable
18 side piece of the pulley block carrier
19a first guide rollers
19b second guide rollers
20 deflection rollers
21a expander cord
36 footplate
37 small rollers
109 first pulley block
110 second pulley block
113 pulley block carrier
134 guide profile
135 hole pattern
136 hole pattern lines
137 smaller holes
138 larger holes
140 pulleys
141 pulley axle
142 semicircular frame
150 carrier element
151 securing bar (fold-out)

### FIGS. 7-10

3 cable
201 supply system
204 face profiles
205 lateral parts
209 first pulley block
210 second pulley block
211 first axle
212 second axle
213 pulley block carrier
214 pulleys
215 pulley wheels
216 ball bearing
217 free end of the cable
218 side piece of the pulley block carrier
219a first guide rollers
219b second guide rollers
220 deflection rollers
221a expander cord
221b (high-tensile) cord
222 first fastening point
223 second fastening point
234 guide profile
235 frame
236 footplate

What is claimed is:

1-16. (canceled)

17. A supply system for an electrical line, in particular for a cable for charging electric vehicles, comprising at least one cable store, wherein the cable store comprises a plurality of pulleys, which are arranged in at least two pulley blocks such that a cable can be reeved into the pulley blocks in one or more windings, wherein a first pulley block and a second pulley block are displaceable relative to each other, at least one of the first and second pulley blocks is arranged on a linearly guided, displaceable pulley block carrier, and the first and the second pulley block are movable towards each other against a restoring force,
wherein the pulley block carrier is guided on and/or in at least one guide profile which is formed as a guide rail or forms at least one guide rail, in that the pulley block carrier is formed as a profile that is complementary to the guide profile and in that the guide profile and the profile of the pulley block carrier engage in each other in a positive-locking manner such that an anti-tilt and anti-twist linear guidance of the pulley block carrier is brought about in the displacement direction, wherein the guide profile is formed as a central guide column which can be installed in a self-supporting manner, and which is formed as a supporting component part for both pulley block carriers, the cable laid thereon as well as the retracting mechanism, and in that the second pulley block is fastened on one side and cantilevered on the pulley block carrier and in that at least one pulley block has in each case multiple pulleys arranged distributed in an arc shape over a circular arc around a deflection axis and at least one of the first and second pulley blocks is arranged and held on the displaceable pulley block carrier.

18. The supply system according to claim 17, wherein the first pulley block is arranged fixed in position and in that the second pulley block is displaceable with respect to the first pulley block on the pulley block carrier.

19. The supply system according to claim 17, wherein the pulley block carrier is formed as a carriage which is supported on guide bars or profiled belts of the guide profile via guide rollers and/or via sliding guides.

20. The supply system according to claim 17, wherein the guide profile has at least one hole pattern and/or tooth pattern continuing at least in the displacement direction of the pulley block carrier as part of a return stop acting against the restoring force.

21. The supply system according to claim 20, wherein the return stop is formed as a retaining pawl.

22. The supply system according to claim 20, wherein, in the displacement direction of the pulley block carrier, the return stop comprises a plurality of discrete locking positions and a plurality of discrete release positions provided between the locking positions for at least one pawl, which can be deflected against a spring force and which is preferably mounted deflectable against a spring force on the pulley block carrier.

23. The supply system according to claim 17, wherein the guide profile comprises at least one hole pattern extending in the displacement direction of the pulley block carrier, in that the hole pattern comprises a plurality of first smaller holes which each form a locking position for a pawl engaging in them and in that the hole pattern comprises a plurality of second larger holes which each form a release position for a pawl dipping into them.

24. The supply system according to claim 20, wherein the return stop comprises at least one pawl which has at least one locking tooth and at least one sliding tooth, wherein the locking tooth is formed for blocking engagement in the hole pattern and the sliding tooth is arranged offset parallel to a pivot axis of the pawl and formed as a pivot limit stop for the pawl.
